(19) United States
(12) Patent Application Publication
(10) Pub. No.: US 2007/0267379 A1
(43) Pub. Date: Nov. 22, 2007

(54) REVERSIBLE TWO-FUNCTION CAP FOR VIAL

(75) Inventor: David Creasap, Heath, OH (US)

Correspondence Address: GIFFORD, KRASS, SPRINKLE,ANDERSON & CITKOWSKI, P.C, PO BOX 7021, TROY, MI, 48007-7021, US

(73) Assignee: Palm-N-Turn, LLC, Heath, OH (US)

(21) Appl. No.: 11/562,727

(22) Filed: Nov. 22, 2006

Related U.S. Application Data
(60) Provisional application No. 60/739,071, filed on Nov. 22, 2005.

(51) Int. Cl. A61J 1/00

(52) U.S. Cl. 215/201

(57) ABSTRACT

A dual-function enclosure device for a vial is provided. The dual-function enclosure device has a first portion and a second portion, wherein the first portion includes an end cap and a cylindrical wall extending axially therefrom. The cylindrical wall has an outer diameter with an annular bead rigidly attached thereto and extending outwardly therefrom. The cylindrical wall with the annular bead frictionally engages a top inner flange on an inner diameter of a vial, thereby affording a non-child-resistant enclosure device for the vial. The second portion includes a skirt, the skirt having an inner surface and an insert inserted therein. The inner surface includes at least one lug rigidly attached thereto and extending away from. The lug engages a bayonet locking element on an outer diameter of the vial, and in combination with the insert affords for a child-resistant enclosure device for the vial. A second embodiment of the invention includes a first portion with an outer cylindrical wall that extends from the intermediate cap in a direction towards the end cap and parallel to the cylindrical wall. The cylindrical wall and the outer cylindrical wall create an annular groove that fits over an open end of the vial.

### CROSS-REFERENCE TO RELATED APPLICATIONS

This application claims priority of U.S. Provisional Patent Application Ser. No. 60/739,071 filed Nov. 22, 2005, which is incorporated herein by reference.

### FIELD OF THE INVENTION

The present invention relates in general to a cap for a vial and in particular to a dual-function cap for a vial.

### BACKGROUND OF THE INVENTION

Closures and container assemblies for use on vials and caps have long been molded from polymers such as polypropylene. U.S. Pat. No. 4,049,148 to Hedgewick discloses a tight vial assembly with a two-piece child-resistant cap. The child-resistant cap includes a base portion and a skirt portion extending axially therefrom and lugs extending radially inwardly from the skirt portion. A yieldable ring portion perfects a seal with the lip of the container as it is urged against the lip of the container during engagement of the lugs with the outer surface of the container. Many times it is desirable to provide a non-child-resistant closure for a vial. In such cases, a separate snap-on cap can be provided.

### BRIEF SUMMARY OF THE INVENTION

A dual-function vial enclosure device is provided. The dual-function enclosure device has a first axially extending portion and a second axially extending portion, wherein the first portion includes a skirt, the skirt having an inner surface and an insert inserted therein. The inner surface of the skirt has at least one lug that is rigidly attached thereto and extends outwardly therefrom. The lug affords for the engagement of a bayonet locking element on the outer surface of a vial, and in combination with the insert affords for a child-resistant enclosure device or cap for the vial. The second portion includes an end cap and a cylindrical wall. The cylindrical wall has an outer surface with an annular bead rigidly attached thereto and extending outwardly therefrom. The cylindrical wall with the annular bead frictionally engages a top inner flange on the inner surface of the vial and thereby affords a non-child-resistant enclosure device or cap for the vial. A second embodiment of the invention includes a second axially extending portion with an outer cylindrical wall that extends from a radially extending portion and is approximately parallel to the cylindrical wall. The cylindrical wall and the outer cylindrical wall create an annular groove that accepts the open end of the vial and fits over said end.

### BRIEF DESCRIPTION OF THE FIGURES

FIG. 1 is a perspective view of a first embodiment of the present invention;

FIG. 2 is a perspective view of an insert used in the present invention;

FIG. 3 is a perspective view of a first embodiment of the present invention enclosing a vial and providing a child-resistant enclosure;

FIG. 4 is a cross-sectional side view of a first embodiment of the present invention wherein a child-resistant enclosure is shown;

FIG. 5 is a perspective view of a first embodiment of the present invention wherein a non-child-resistant enclosure is shown;

FIG. 6 shows a perspective and phantom view of a first embodiment of the present invention wherein a non-child-resistant enclosure is shown;

FIG. 7 is a side cross-sectional view of a first embodiment of the present invention wherein a non-child-resistant enclosure is shown;

FIG. 8 shows a perspective view of a second embodiment of the present invention wherein a non-child-resistant enclosure is shown;

FIG. 9 is a perspective and phantom view of a second embodiment of the present invention wherein a vial is enclosed with a non-child-resistant device; and

FIG. 10 is a cross-sectional side view of a second embodiment of the present invention wherein a non-child-resistant enclosure is shown.

### DETAILED DESCRIPTION OF THE INVENTION

A reversible dual-function enclosure device, also known as a cap, for vials is provided. When mounted in one direction, the enclosure device functions as a child-resistant cap. When the enclosure device is inverted and mounted in the other direction, the cap functions as a non-child-resistant cap. Both functions are usable on the same size child-resistant vial. Furthermore, the inventive cap can be manufactured from any material known to those skilled in the art, illustratively including polymers such as polypropylene.

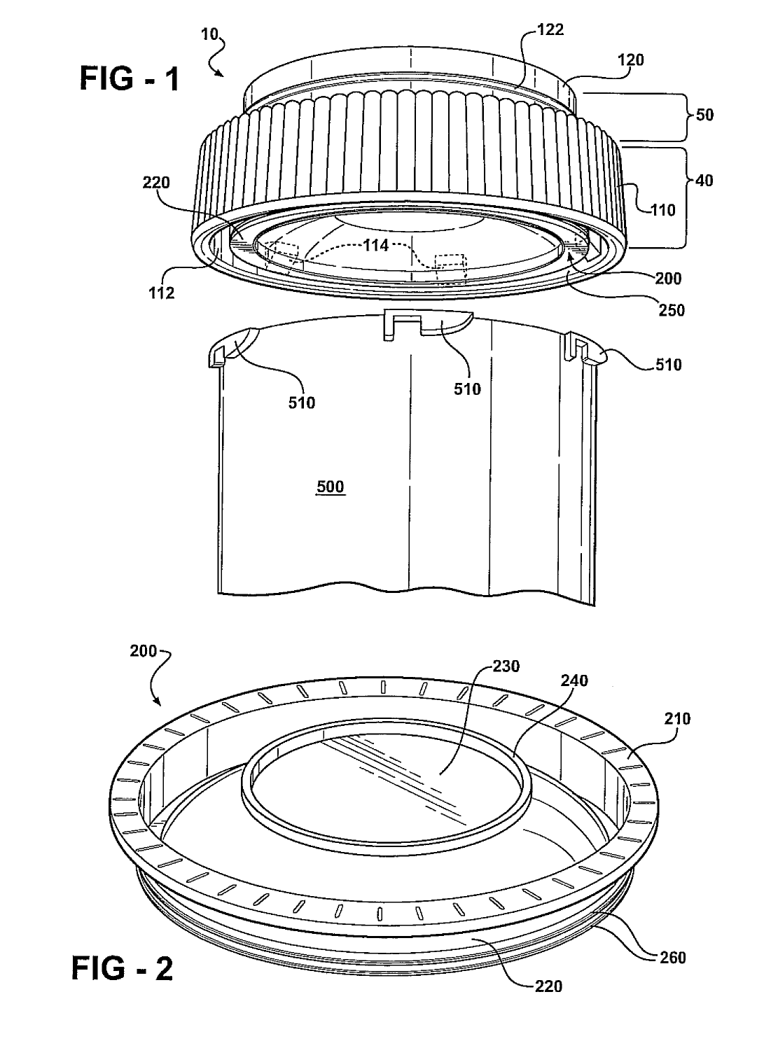

As shown in FIG. 1, a first embodiment of the present invention is shown generally at 10 and includes a first axially extending portion 40 and a second axially extending portion 50. The first axially extending portion 40 includes a skirt 110 having an inner surface 112 and at least one lug 114 fixedly attached to the inner surface 112 and extending outwardly therefrom. Inserted within the skirt 110 is an insert 200, which in combination with first portion 40 affords for a child-resistant cap for a vial. In the alternative, the inventive cap of the present invention does not require insert 200.

The second axially extending portion 50 includes an end cap 130 (see FIG. 5) and a cylindrical wall 120. The cylindrical wall 120 has an outer surface 124 and an annular bead 122 rigidly attached to the outer surface 124. A radially extending portion 140 (see FIG. 5) adjoins the first portion 40 to the second portion 50. For illustrated purposes only, FIG. 5 shows the end cap 130 attached to the cylindrical wall 120 at the furthest end from the radially extending portion 140. In the alternative, the end cap 130 is not attached to the cylindrical wall 120 at the furthest end from the radially extending portion 140 and can be located anywhere along said wall 120 in the second portion 50.

If insert 200 is employed in the present invention, said insert 200 has a circumferential edge portion 210, an axially extending annular portion 220 and a center dome portion 230 (FIG. 2). A flange 240 extends outwardly from the convex side of the dome portion 230 and contacts a flange 160 extending from the end cap 130 of second portion 50 (see FIG. 4). The edge portion 210 has an outer diameter slightly larger than an inner diameter of the first portion 40 such that an interference fit is provided with the inner surface 112 of the skirt 110. Preferably the outer diameter of edge portion 210 is between 1 and 25% larger than the inner diameter of the first portion 40, and more preferably is between 2 and 15% larger. Even more preferable, the outer diameter of edge portion 210 is between 2 and 10% larger than the inner diameter of edge portion 210.

The annular portion 220 is spaced apart from the inner surface 112 of the skirt 110 in order to form a recess 250 for the receiving of the vial 500 between (FIG. 1). In addition, the annular portion 220 has a pair of radially extending ridges 260 which are received on the inside of the vial 500 to frictionally engage the top flange 520 of the vial.

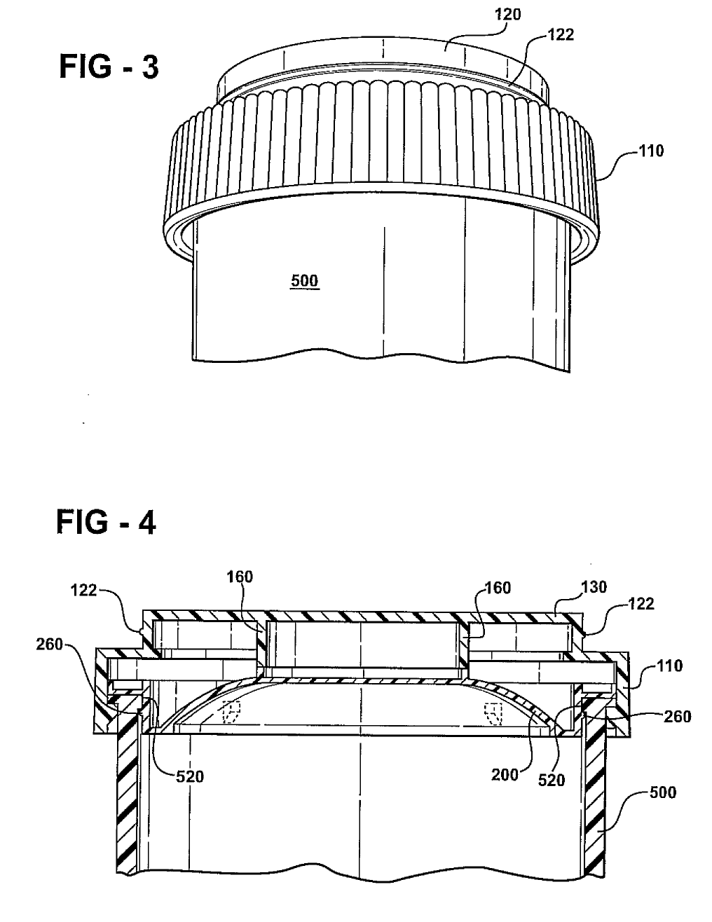

As shown in FIGS. 1-4, and disclosed in U.S. Pat. No. 4,049,148 which is incorporated herein by reference, the vial 500 has bayonet locking elements 510 which engage the lugs 114 of the skirt 110 by rotative motion of the cap 10 relative to the vial 500. The annular portion 220 of the insert 200 biases against the lip of the vial to provide a seal in the same fashion as disclosed in U.S. Pat. No. 4,049,148 and known to those skilled in the art. The cap is removed in the same fashion.

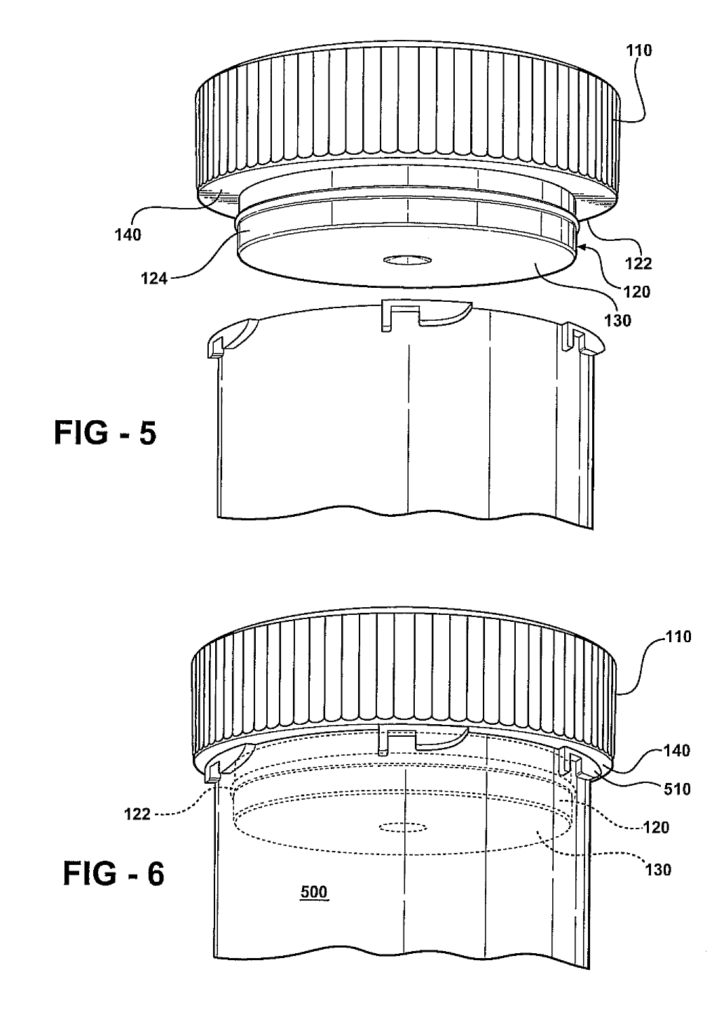

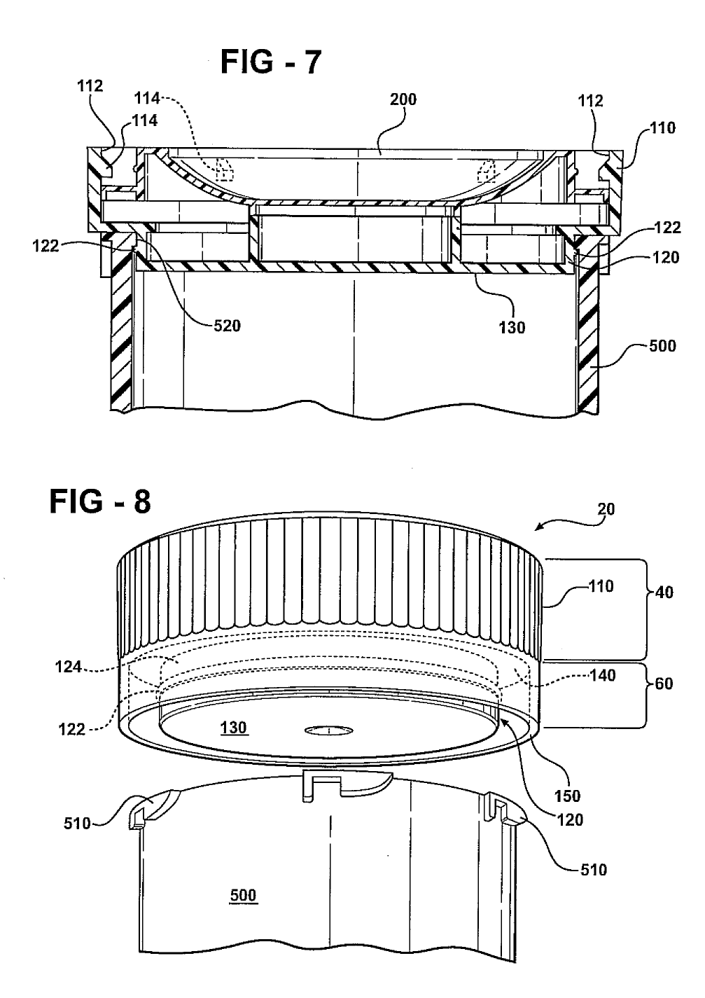

Turning to FIGS. 5-7, the second portion 50 of cap 10 affords a non-child-resistant enclosure device for a child-resistant vial when the cylindrical wall 120 with annular bead 122 thereon is inserted into the vial 500 (FIG. 6). The insertion of the second portion 50 into the vial results in annular bead 122 frictionally engaging top flange 520 of vial 500 (FIG. 7). The engagement of annular bead 122 with top flange 520 provides for a “snap fit” between the second portion 50 and the vial 500. In this manner, a dual-functional vial enclosure device is provided.

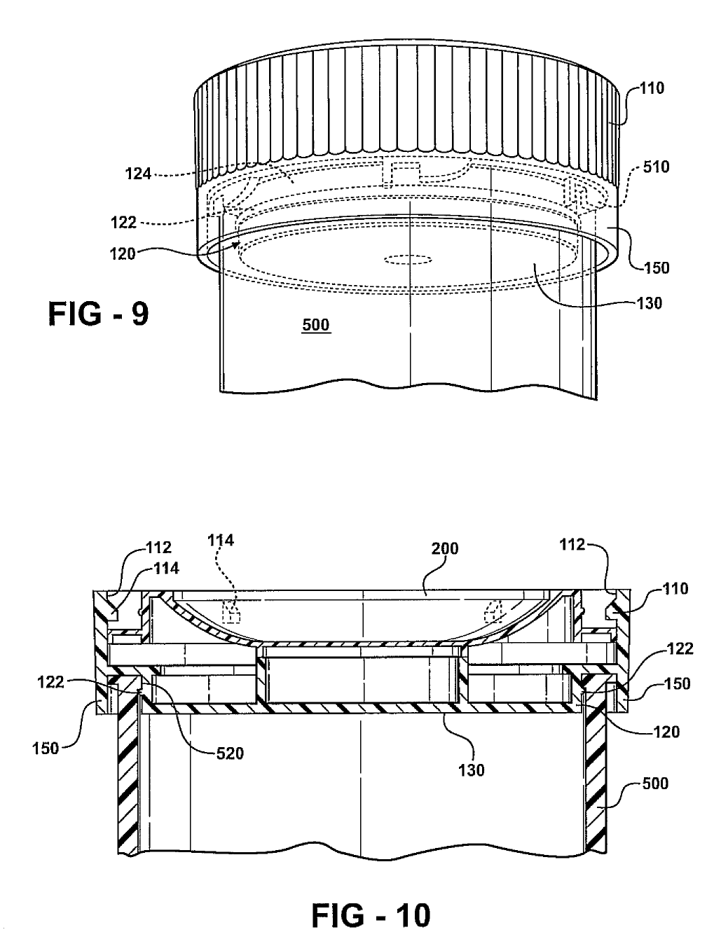

Turning now to FIGS. 8-10, a second embodiment of the present invention is shown generally at 20. The second embodiment includes a first axially extending portion 40, which is identical to the first portion 40 of the first embodiment shown in FIGS. 1-7, and a second axially extending portion 60. The second portion 60 includes the end cap 130 and the cylindrical wall 120. The radially extending portion 140 first axially extending portion and second axially extending portion 60. In addition to the cylindrical wall 120 with the outer surface 124 and annular bead 122 rigidly attached thereto, the dual-function cap 20 includes an outer cylindrical wall 150 extending from the radially extending portion 140 parallel to cylindrical wall 120. In the alternative, outer cylindrical wall 150 extends from portion 140 non-parallel to wall 120. The engagement of annular bead 122 with top flange 520 provides for a snap fit between second portion 20 and the vial 500 as disclosed above for the second portion 50 and the vial 500 of the first embodiment. Furthermore, outer cylindrical wall 150 covers bayonet locking elements 510 of the vial 500 when said cap is placed thereon in a non-child-resistant manner.

The invention is not restricted to the illustrative examples described above. The examples are not intended as limitations on the scope of the invention. Methods, apparatus, compositions, and the like described herein are exemplary and not intended as limitations on the scope of the invention. Changes therein and other use will occur to those skilled in the art. The scope of the invention is defined by the scope of the claims.

1. A dual-function vial enclosure device comprising:
a radially extending portion adjoining a first axially extending portion and a second axially extending portion, said second portion extending in an opposite direction from said first portion;
said first axially extending portion including a skirt with an inner surface, said inner surface having a lug rigidly attached thereto and extending outwardly therefrom; and
said second axially extending portion including an end cap and a cylindrical wall, said cylindrical wall having an outer surface with an annular bead rigidly attached thereto and extending outwardly therefrom, for the purpose of said first axially extending portion affording a child-resistant enclosure device for a vial and said second axially extending portion affording for a non-child-resistant enclosure device for a vial.

2. The invention of claim 1, further comprising an insert, said insert comprised of a circumferential edge portion, an axially extending annular portion and a center dome portion.

3. The invention of claim 2, wherein said circumferential edge portion has an outer diameter slightly larger than an inner diameter of said first axially extending portion, for the purpose of affording an interference fit between said insert and said inner surface of said skirt.

4. The invention of claim 2, wherein said annular portion of said insert is spaced apart from said inner surface of said skirt, for the purpose of affording a recess between said inner surface of said skirt and said annular portion.

5. The invention of claim 2, wherein said annular portion of said insert includes a radially extending ridge, for the purpose of frictionally engaging a top flange of the vial.

6. The invention of claim 1, wherein said annular bead is continuous about said cylindrical wall and frictionally engages a top inner flange on an inner surface of the vial, for the purpose of affording a non-child-resistant enclosure device for the vial.

7. The invention of claim 1, wherein said inner surface of said skirt includes a plurality of lugs, said lugs engaging a plurality of bayonet locking elements of the vial, for the purpose of affording a child-resistant enclosure device for the vial.

8. A dual-function enclosure device for a vial comprising:
a radially extending portion adjoining a first axially extending portion and a second axially extending portion, said second portion extending in an opposite direction from said first portion;
said first axially extending portion including a skirt with an inner surface, said inner surface having a plurality of lugs rigidly attached thereto and extending outwardly therefrom, said lugs engaging a plurality of bayonet locking elements of a vial and affording a child-resistant enclosure device for the vial; and
said second axially extending portion including an end cap and a cylindrical wall, said cylindrical wall having an outer surface with an annular bead rigidly attached thereto and extending outwardly therefrom, said outer surface with said annular bead frictionally engaging a top inner flange on an inner surface of the vial and affording a non-child-resistant enclosure device for the vial, for the purpose of providing a dual-function enclosure device for the vial.

9. The invention of claim 8, further comprising an insert, said insert comprised of a circumferential edge portion, an axially extending annular portion and a center dome portion.

10. The invention of claim 9, wherein said circumferential edge portion has an outer diameter slightly larger than an inner diameter of said first axially extending portion, for the purpose of affording an interference fit between said insert and said inner surface of said skirt.

11. The invention of claim 9, wherein said annular portion of said insert is spaced apart from said inner surface of said skirt, for the purpose of affording a recess between said inner surface of said skirt and said annular portion.

12. The invention of claim 9, wherein said annular portion of said insert includes a radially extending ridge, for the purpose of frictionally engaging a top flange of the vial.

13. The invention of claim 8, wherein said second axially extending portion includes an outer cylindrical wall extending from said intermediate cap in a direction towards said end cap and parallel to said cylindrical wall.
